(19) United States
(12) Patent Application Publication
(10) Pub. No.: US 2005/0114204 A1
(43) Pub. Date: May 26, 2005

(54) Advertisement providing system using video chatting service and the method thereof

(76) Inventors: Jong-Kyung Kim, Seongnam-si (KR); Sun-Young Kwon, Seoul (KR)

Correspondence Address: Robert E. Bushnell, Suite 300, 1522 K Street, N.W., Washington, DC, 20005-1202, US

(21) Appl. No.: 10/716,413

(22) Filed: Nov. 20, 2003

(51) Int. Cl. G06F 17/60

(52) U.S. Cl. 705/14

(57) ABSTRACT

An advertisement providing system and a method thereof for displaying advertisements on the unused image displaying windows in a video chatting service are disclosed. The advertisement providing system using a video chatting service comprises: a chatter number checking means that checks the number of maximum allowable chatters, the number limit of chatters set by a room creator and the number of actually-participating users of each chatting room; an image displaying window administration means that receives the image inputs of the users in each chatting room and administrates the used/unused states of the image displaying windows in each chatting room; and an advertisement creation/control means that receives advertisement information from sponsors, manipulates said information into web-posting-type materials, and transmits the created advertisements to the chatting service providing system to be displayed on the unused image displaying windows.

### BACKGROUND OF THE INVENTION

1. Field of the Invention

The present invention relates to an advertisement providing system. In more detail, it relates to an advertisement providing system using the unused image-displaying windows of video chatting service and the method thereof.

2. Description of the Related Art

As personal computers (PCs) and Internet are being popularized, businesses for providing various contents to users using Internet are being rapidly developed. Among the various contents provided through Internet, chatting service has been being spotlighted as a representative content service from the past generation, when PC communication was being performed through telephone line, to the present.

Chatting service is a service with which numbers of users, being connected to a communication network, can talk to each other through messages. Nowadays, owing to the high transmission speed of network and the massive scale of PC, a video chatting service, with which a user can send/receive messages with seeing his (or her) chatting companion's appearance by using an image processing device like a digital camera equipped in his (or her) PC, is being universalized. Different from the prior chatting service only transferring the messages, a video chatting service provides image windows displaying chatters' features so that it can increase the chatting interest.

In video chatting, a user usually limits the number of participating chatters in a chatting room to a certain number when he (or she) creates the chatting room. That is to say, a user often limits the number of chatters to be 5 whereas the number of maximum allowable chatters in a chatting room is generally set to be 10 in an ordinary video chatting service. And in consequence, not a few numbers of image displaying windows are being remained empty.

Meanwhile, various advertising methods through Internet are being widely used along with the wide-spread of Internet, such as banner advertisements automatically appeared when connected to a specific web-site, advertisements appeared during the web-page changing interval by using the connection time to the next web-site, and so on. However a user mainly concentrates on specific contents of the visiting web-site, and thus banner advertisements can hardly induce the user interest. Besides, since an advertisement appeared during the web-site-changing interval generally uses a short time period, it is very difficult to give a deep impression of the advertisement to a user.

### SUMMARY OF THE INVENTION

The present invention is proposed to solve the problems of the prior art mentioned above. It is therefore the object of the present invention to provide a method for efficiently using the image displaying windows in a video chatting service by utilizing the unused image displaying windows as advertisement displaying windows when providing a video chatting service.

It is another object of the present invention to provide useful information to the users in a chatting room by proving advertisements, appropriate to the characteristics of the chatting room and the participating users, on the surplus image displaying windows.

To achieve the object mentioned above, the present invention provides an advertisement providing system, that displays the advertisements requested to be posted by sponsors on the image displaying windows of a chatting room when the chatting room is being created in a video chatting service system, with being connected to the chatting service providing system, which provides a video chatting service to numbers of users connected to the system through their PCs having appropriate image processing devices. The system comprises a control section; a chatter number checking means that periodically checks the number of maximum allowable chatters, the number limit of chatters set by a room creator and the number of actually-participating users in each chatting room, and stores the checking results into a database; an image displaying window administration means that receives the image inputs of the users in each chatting room from the chatting service providing system and administrates the used/unused states of the image displaying windows in the chatting room; and an advertisement creation/control means that receives advertisement information from sponsors, manipulates the information into web-posting-type materials and stores them into a database, and when an unused image displaying window is being detected in a chatting room by the image displaying window administration means, transmits the advertisement material stored in the database to the chatting service providing system, by the control of the control section, to be displayed on the unused image displaying window.

In addition, an advertisement providing system in accordance with the present invention can further comprise a chatting room analysis means that receives the information related to each chatting room from the chatting service providing system, analyzes the characteristics of each chatting room by using the information on the subject of the chatting room and the sexualities, ages and occupations of the participating users in the chatting room, and stores the analyzed result into a database; and a linked-page administration means that stores the URLs of the web-pages linked to the advertisements displayed on the image displaying windows into a database and administrates them.

Here, the advertisement creation/control means stores the advertisements according to their subjects, objects and/or themes. And the advertisements can be created in the forms of texts, images, moving pictures, or any combinations. In addition, the present invention also provides an advertisement providing method, that stores the advertisements requested to be posted by sponsors and displays them on the image displaying windows of a chatting room with being connected to a chatting service providing system, which provides a video chatting service to numbers of users connected to the system through their PCs having appropriate image processing devices, characterized by comprising the steps of: (a) manipulating the advertisements requested to be posted by the sponsors into the web-posting-type materials and storing them; (b) receiving the chatting room-related information from the chatting service providing system and checking that the number of participating users in the chatting room exceeds the number of maximum allowable chatters of the room; (c) checking that the user's image data is being displayed on each image displaying window in the chatting room; and (d) when an unused image displaying window, among the image displaying windows of the chatting room, is being detected in step (c), transmitting the created advertisement to the chatting service providing system.

### BRIEF DESCRIPTION OF THE DRAWINGS

FIG. 1 is a view illustrating an example of a communication network where an advertisement providing system in accordance with the present invention is being applied.

FIG. 2 is a structural diagram illustrating the detailed structure of the advertisement providing system described in FIG. 1.

FIG. 3 is a flowchart illustrating an advertisement providing method in accordance with the present invention.

FIG. 4 is a block diagram illustrating an embodiment of the advertisement providing method in a chatting room in accordance with the present invention.

### DETAILED DESCRIPTION OF THE EMBODIMENTS

Hereinafter, referring to appended drawings, the preferred embodiments of the present invention are described in detail.

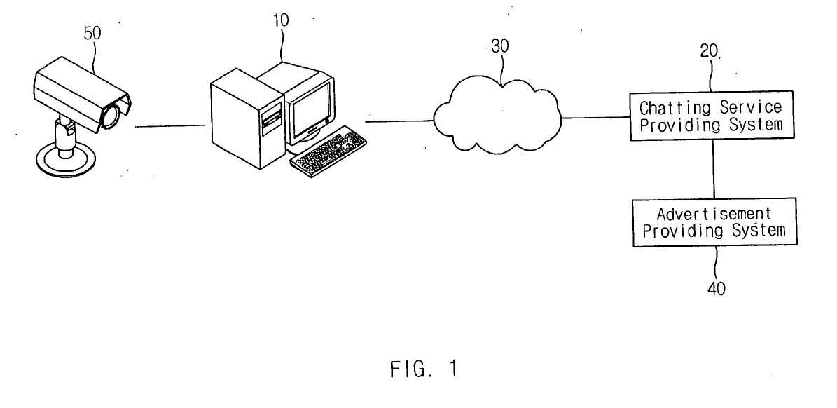

FIG. 1 is a view illustrating an example of a communication network where an advertisement providing system in accordance with the present invention is being applied.

As described in the figure, an image-processing device like a digital camera 50 can be installed at a PC 10, and a user can connect to a chatting service providing system 20 through Internet 30 to use a video chatting service.

An advertisement providing system 40 is connected to a chatting service providing system 20, and when a user connects to the chatting service providing system 20 using a PC 10 and creates a video chatting room, it displays advertisements on the surplus image displaying windows where chatter's images are not being displayed. It is preferred that the advertisement providing system 40 is being operated by the chatting service providing system 20 operator, however, it can be also operated by another operator independent of the chatting service providing system 20. The advertisements displayed by the advertisement providing system 40 are produced to be web-posting-type materials in the forms of texts, images, moving pictures, or any combinations.

In a preferred embodiment of the present invention, the advertisement pages are designed to be linked to the related web-pages when a user is clicking the mouse on the image displaying windows where the advertisements are being displayed.

A user connects to the chatting service providing system 20 through Internet 30 by using a PC 10 at which a digital camera 50 is installed. When connected to the chatting service providing system 20, a user can create a specific chatting room or participate in a pre-established chatting room. The advertisement providing system 40 checks the number of maximum allowable chatters, the chatter number limit set by the room creator, and the number of user image information actually being inputted for each of the chatting rooms being operated respectively. And then, it transmits advertisement data to the chatting service providing system 20 and requests that the advertisements are to be displayed on the image displaying windows, where the user image information are not being displayed, in the chatting room where the number of actually-participating users are less than that of maximum allowable chatters.

Here, the advertisements can be displayed on as many image displaying windows as the difference between the number of maximum allowable chatters and the chatter number limit set by the room creator. Or, the advertisements can be displayed on as many image displaying windows as the difference between the number of maximum allowable chatters and that of actually-participating users (i.e. all the unused image displaying windows), and in case that other users are additionally joining to the room, as many advertisements as the number of added chatters can be deleted.

When advertisements are being displayed in a chatting room, it is preferred that the advertisements, fit for the characteristics of the chatting room and the participating users, are displayed with considering the theme of the room and the sexualities, ages and occupations of the participating users. To satisfy this preference, the chatting service providing system 20 should provide all the information related to the created chatting rooms to the advertisement providing system 40.

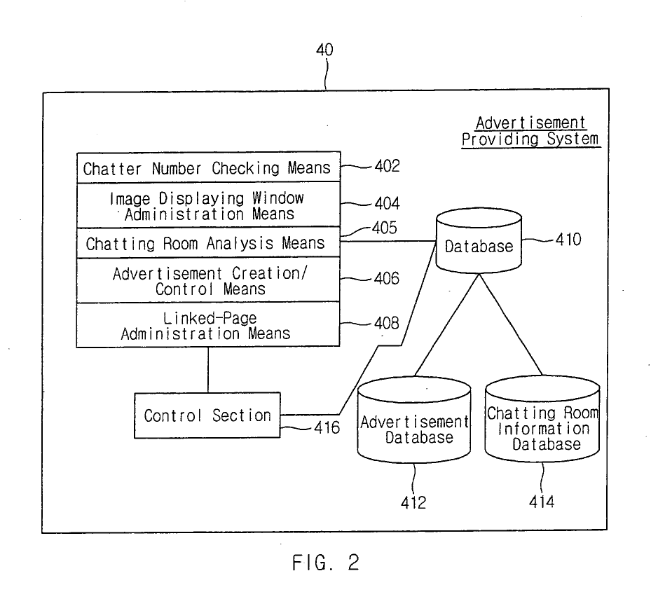

FIG. 2 is a structural diagram illustrating the detailed structure of the advertisement providing system described in FIG. 1.

As described in FIG. 2, an advertisement providing system 40 in accordance with the present invention comprises a chatter number checking means 402, an image displaying window administration means 404, a chatting room analysis means 405, an advertisement creation/control means 406, a linked-page administration means 408, a database, and a control section 416 for controlling the operations of the above-described functional means and the database 410. Here, the database 410 comprises an advertisement database 412 and a chatting room information database 414, and these databases can be constituted in a single table or in two different tables respectively. Once chatting rooms are created by the users connected to the chatting service providing system 20, the chatter number checking means 402 periodically checks the number of maximum allowable chatters, the number limit of chatters set by each room creator and the number of actually-participating users for each created chatting room and stores the checking results into a chatting room information database 414.

When users' image information are inputted to the chatting service providing system 20 from the PCs 10, each of which is being equipped with a digital camera 50, the image displaying window administration means 404 receives the image inputs of the users in each chatting room from the chatting service providing system 20 and administrates the used/unused states of the image displaying windows in the chatting room.

The chatting room analysis means 405 receives the information related to each chatting room from the chatting service providing system 20 and analyzes the characteristics of each chatting room by using the information on the subject of the chatting room and the sexualities, ages and occupations of the participating users in the chatting room.

The advertisement creation/control means 406 creates the advertisements to be displayed on the image displaying windows in the forms of texts, images, moving pictures, or any combinations, stores them into the advertisement database 412, and renews the advertisement database 412 whenever a new advertisement posting request is being inputted. When storing the advertisements into the advertisement database 412, it is preferred to classify the advertisements according to the pre-established subjects, objects and/or themes so that the appropriate advertisements to the characteristics of each chatting room can be easily selected. The advertisements, created and stored in the forms of texts, images, moving pictures, or any combinations, are displayed on the monitors of the users using the chatting service in the most suitable forms to their computer specifications. The advertisements created by the advertisement creation/control means 406 are transmitted to the chatting service providing system 20, when there exist any unused image displaying windows in the chatting room, by the control of the control section 416 and displayed on the unused image displaying windows.

The linked-page administration means 408 stores the URLs of the web-pages linked to the advertisements displayed on the image displaying windows into the advertisement database 412 and administrates them. All the advertisements displayed on the image displaying windows do not need to have linked-pages, however, the advertising effect can be maximized with linked-pages being designated. When a user clicks the mouse on an image displaying window where an advertisement is being displayed, the linked web-page comes out on the screen by the control of the control section 416.

The advertisement providing system 40 further comprises a network interface (not described in the figure) and transmits/receives necessary data to/from the chatting service providing system 20 through the network interface by the control of the control section 416. Whenever a chatting room is created or renewed, the chatting service providing system 20 transmits the changed information to the advertisement providing system 40. And then, the advertisement providing system 40 renews the chatting room information database 414 according to the transmitted chatting room information and displays an appropriate advertisement when an unused image window is being detected.

When advertisements are being displayed in a chatting room, it is preferred that the advertisements, useful for the participating users in the chatting room, are displayed based on the analysis results from the chatting room analysis means 404 derived by using the chatting room information such as the subject of the room and the sexualities, ages and occupations of the participating users.

The number of advertisement displaying windows is decided by the chatter number checking means 402. The number can be the same as the difference between the number of maximum allowable chatters and the chatter number limit set by the room creator or the difference between the number of maximum allowable chatters and that of actually-participating users. In latter case, if chatters are additionally joining to the room, as many advertisements as the number of added chatters are deleted. The deleting priorities of the advertisements can be arbitrarily set by the operator of the advertisement providing system 40.

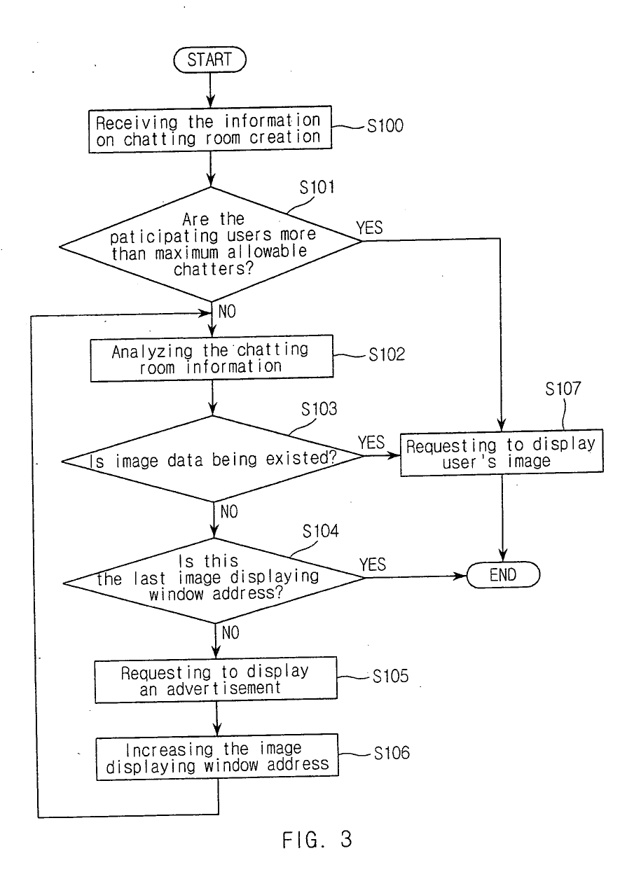

FIG. 3 is a flowchart illustrating an advertisement providing method in accordance with the present invention. To display advertisements on the unused image displaying windows in a video chatting service, it has to be preceded to manipulate the advertisements, posting-requested by sponsors, into web-posting-type materials and store them.

Once at least one (or more) chatting room is created by at least one user connected to the chatting service providing system 20 through PC 10 having a digital camera 50, the advertisement providing system 40 periodically receives the chatting room-related information from the chatting service providing system 20, S100.

After receiving the chatting room related information on each chatting room from the chatting service providing system 20, the advertisement providing system 20 first checks whether the number of participating users in each chatting room exceeds the number of maximum allowable chatters of the room and stores the information into the chatting room information database 414, S101. If the checking result shows that the numbers of participating chatters in some chatting rooms do not exceed the numbers of maximum allowable chatters of the rooms, it analyzes the characteristics of each of the chatting rooms using the chatting room information, received from the chatting service providing system 20, such as the subject of the chatting room and the sexualities, ages and occupations of the participating users S102. Next, it checks that the image data transmitted from the participating users are being displayed on the corresponding image displaying windows in the chatting room. At this step, it is preferred to check the image displaying windows in sequence.

The detailed description on the process for checking that the users' image data are being displayed on the image displaying windows is as follows: Here, it is premised that each image displaying window has a physical address, with which it can be identified internally in the system. First, it checks whether or not the image data inputted from a user is being displayed on the image displaying window corresponding to the first address S103. If no image data is being displayed thereon, it checks whether the corresponding window address is that of the last image displaying window S104.

If the checked address is not that of the last window, it selects an appropriate advertisement to the chatting room characteristics, analyzed by the chatting room analysis means 404, from the advertisement database 412. And then, it transmits the selected advertisement to the chatting service providing system 20 to be displayed in the chatting room S105. Afterwards, it increases the image displaying window address S106 and then, go back to the step S103 of checking the image data being displayed on the image displaying window. By repeating these procedures on the entire existing image displaying windows, the advertisements can be displayed on all the unused windows where users' images are not being displayed.

On the other hand, if it is noticed that, in the step of checking the number of participating users, the number of participating users is no less than the number of maximum allowable chatters of the chatting room, it requests the chatting service providing system 20 to display the users' images on all image displaying windows S107. Additionally, in the step 103 of checking whether the image data is being inputted on each image displaying window, if it is noticed that the image data is being inputted, the advertisement providing system 40 also requests the chatting service providing system 20 to continuously display the inputted users' images S107.

If it is noticed that the checked image displaying window is the last one in the step S104 of checking whether the image displaying window to be checked is the last one, it terminates the advertisement providing process because it means that the system has checked all the image displaying windows and displayed the advertisements on every possible windows.

In a preferred embodiment of the present invention, a user, who is using the chatting service, can move to the web-pages linked to the displayed advertisements by simply clicking the mouse on the image displaying windows where the advertisements are being displayed. With this feature, the present invention can maximize the advertising effect and provide necessary information to the user in detail.

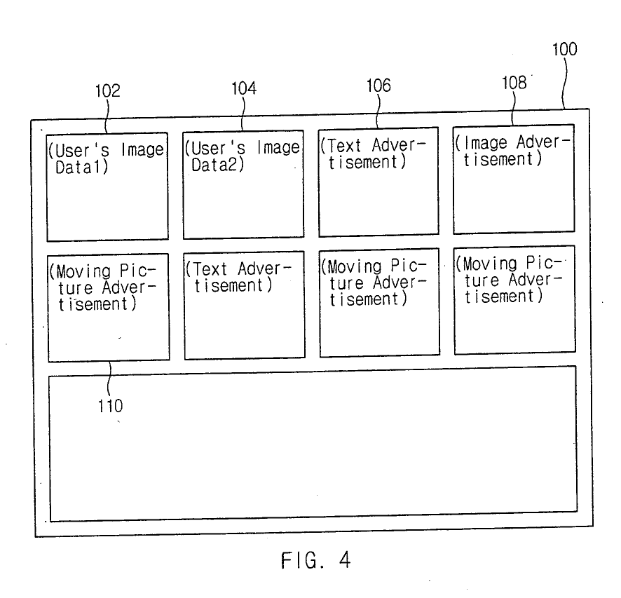

FIG. 4 is a block diagram illustrating an embodiment of the advertisement providing method in a chatting room in accordance with the present invention.

As described in the figure, image displaying windows 102, 104 for displaying the image information of the users participating in a video chatting room are appeared on the upper portion of a monitor 100 and the conversation window is appeared on the bottom. FIG. 4 shows the case of two users being participated in a chatting room. In this case, various web-posting types of advertisements such as texts, images, and/or moving pictures can be displayed on the rest of the image displaying windows except the two image displaying windows 102, 104 where the users' image data are being displayed.

So, in accordance with the present invention, it displays the advertisements on the rest six image displaying windows in a chatting room, whose number of maximum allowable chatters is eight, wherein only two users are having conversation, and thus the advertisements are constantly being displayed on the monitor screen while the users are using the chatting service. In addition, if the related web-pages are linked to the advertisements, a user can quickly move to the related web-page, when necessary, to get more detailed information by simply clicking his (or her) mouse on the corresponding advertisement.

As mentioned thereinbefore, the present invention can maximize the advertising effect by providing the advertisements on the unused image displaying windows in a video chatting service. Additionally, it can provide more useful advertisements to the users by selectively posting the advertisements appropriate to the characteristics of a chatting room and the participating users. And in the case of the related web-pages being linked to the displayed advertisements, a user can directly move to the advertisement-related web-pages to obtain more detailed information.

Since those having ordinary knowledge and skill in the art of the present invention will recognize additional modifications and applications within the scope thereof, the present invention is not limited to the embodiments and drawings described above. The scope of the present invention is therefore to be represented by the claims that will be described hereinafter, and it is needless to say that the claims of the present invention are to be interpreted to include all the non-inventive modifications and applications able to be derived from the subjects of themselves and their equivalents.

1. An advertisement providing system, using a video chatting service, that displays the advertisements requested to be posted by sponsors on the image displaying windows of the chatting rooms when said chatting rooms are being created in a video chatting service system, with being connected to said chatting service providing system, which provides a video chatting service to numbers of users connected to the system through their PCs having appropriate image processing devices, characterized by comprising:
a control section;
a chatter number checking means that periodically checks the number of maximum allowable chatters, the number limit of chatters set by a room creator and the number of actually-participating users of each of said chatting rooms, and stores the checking results into a database;
an image displaying window administration means that receives the image inputs of the users in each chatting room from said chatting service providing system and administrates the used/unused states of the image displaying windows in each chatting room; and
an advertisement creation/control means that receives advertisement information from sponsors, manipulates said information into web-posting-type materials and stores them into said database, and when unused image displaying windows are being detected in a chatting room by said image displaying window administration means, transmits said advertisement materials stored in said database to said chatting service providing system, by the control of said control section, to be displayed on said unused image displaying windows; and
a chatting room analysis means that receives the information related to each chatting room from said chatting service providing system, analyzes the characteristics of each chatting room by using said information on the subject of each chatting room and the sexualities, ages and occupations of the participating users in each chatting room, and stores the analyzed result into said database.

2. An advertisement providing system using a video chatting service as claimed in claim 1, wherein said advertisement creation/control means stores said advertisements according to the subject, object, and theme of each advertisement.

3. An advertisement providing system using a video chatting service as claimed in claim 1 and 2, wherein said advertisement creation/control means selects the appropriate advertisements to the characteristics of each chatting room.

4. An advertisement providing system using a video chatting service as claimed in claim 1, characterized by further comprising a linked-page administration means that stores the URLs of the web-pages linked to said advertisements displayed on said image displaying windows into said database and administrates them.

5. An advertisement providing system using a video chatting service as claimed in claim 1 and 2, wherein said advertisements are created in the forms of texts, images, moving pictures, or any combinations of those.

6. An advertisement providing method, using a video chatting service, that stores the advertisements requested to be posted by sponsors and displays them on the image displaying windows of a chatting room with being connected to a chatting service providing system, which provides a video chatting service to numbers of users connected to the system through their PCs having appropriate image processing devices, characterized by comprising the steps of:
(a) manipulating the advertisements requested to be posted by said sponsors into web-posting-type materials and storing them;
(b) receiving the information related to said chatting room from said chatting service providing system and checking whether the number of participating users in said chatting room exceeds the number of maximum allowable chatters of said chatting room;
(c) analyzing the characteristics, based on said chatting room information transmitted from said chatting service providing system, of said chatting room and the participating users in said chatting room; and
(d) checking that the corresponding user's image data is being displayed on each image displaying window in said chatting room; and
(e) when an unused image displaying window, among the image displaying windows of said chatting room, is being detected in step (c), transmitting said created advertisements to said chatting service providing system.

7. An advertisement providing method using a video chatting service as claimed in claim 6, wherein said step (e) further comprises the step of selecting advertisements, suitable for said analyzed chatting room characteristics, before transmitting said created advertisements to said chatting service providing system.

8. An advertisement providing method using a video chatting service as claimed in claim 6, wherein said step (b) further comprises the step of requesting said chatting service providing system to display said users' images on said image displaying windows when said number of participating users in said chatting room is no less than said number of maximum allowable chatters of said chatting room.

9. An advertisement providing method using a video chatting service as claimed in claim 6, wherein said step (d) further comprises the step of requesting said chatting service providing system to display said users' image data continuously during said users' image data are being existed on said image displaying windows.

10. An advertisement providing method using a video chatting service as claimed in claim 6, characterized by further comprising the step of providing a connection to the web-pages linked to said displayed advertisements when a user selects said advertisements displayed on said image displaying windows.

11. An advertisement providing method using a video chatting service as claimed in claim 6, 7 and 8 wherein said web-posting-type materials are in the forms of texts, images, moving pictures, or any combinations of those.
